(19) United States
(12) Patent Application Publication
(10) Pub. No.: US 2021/0298148 A1
(43) Pub. Date: Sep. 23, 2021

(54) DC-DC POWER SUPPLY AND LIGHT EMITTING DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventors: Yoichi TOKAI, Shinagawa Tokyo (JP); Toru TAKAYAMA, Yokohama Kanagawa (JP)

(73) Assignees: KABUSHIKI KAISHA TOSHIBA, Tokyo (JP); TOSHIBA ELECTRONIC DEVICES & STORAGE CORPORATION, Tokyo (JP)

(21) Appl. No.: 17/013,123

(22) Filed: Sep. 4, 2020

(30) Foreign Application Priority Data
Mar. 23, 2020 (JP) 2020-051763

(51) Int. Cl. H05B 45/3725; H05B 45/325; H05B 45/34; H05B 45/54

(52) U.S. Cl. CPC H05B 45/3725; H05B 45/54; H05B 45/34; H05B 45/325

(57) ABSTRACT

A DC-DC power supply according to an embodiment includes a voltage converter, a first switching element, a second switching element, and a controller. The voltage converter converts an input voltage into a first voltage. The first switching element performs switching according to a pulse signal to thereby intermit the first voltage applied to one end of a load. One end of the second switching element is connected to the other end of the load. The second switching element performs an ON/OFF operation at a predetermined advance time with respect to the first switching element. The controller controls, based on a voltage at the other end of the second switching element in a one-voltage holder, the first voltage output by the voltage converter.

### CROSS-REFERENCE TO RELATED APPLICATIONS

This application is based upon and claims the benefit of priority from the prior Japanese Patent Application No. 2020-051763, filed on Mar. 23, 2020 the entire contents of which are incorporated herein by reference.

### FIELD

Embodiments of the present invention relate to a DC-DC power supply and a light emitting device.

### BACKGROUND

In a DC-DC converter that energizes a load represented by an LED, in general, color rendering is stabilized and dimming is linearly performed. The color rendering is performed by keeping an electric current during light emission constant. A light emission state and an extinction state are alternately switched. The dimming is performed according to a time ratio of the light emission state and the extinction state. A cathode voltage of the LED is used for feedback in control of such a DC-DC converter.

However, this voltage is affected by fluctuation in a voltage drop of the LED during the switching of light emission and extinction. Accordingly, as a fed-back voltage of the cathode voltage held during the extinction, an output voltage sometimes shifts in a direction showing an excessively small voltage. It is likely that an output voltage of the DC-DC converter increases during the extinction.

### BRIEF DESCRIPTION OF THE DRAWINGS

FIG. 1 is a block diagram showing the configuration of a DC-DC power supply according to an embodiment;

FIG. 2 is a waveform chart of the DC-DC power supply according to the embodiment;

FIG. 3 is a block diagram showing the configuration of a DC-DC power supply according to a comparative example;

FIG. 4 is a waveform chart of the DC-DC power supply according to the comparative example; and

FIG. 5 is a block diagram showing the configuration of a DC-DC power supply according to a modification of the embodiment.

### DETAILED DESCRIPTION

A DC-DC power supply according to this embodiment includes a voltage converter, a first switching element, a second switching element, and a controller. The voltage converter converts an input voltage into a first voltage. The first switching element performs switching according to a pulse signal to thereby intermit the first voltage applied to one end of a load. One end of the second switching element is connected to the other end of the load. The second switching element performs an ON/OFF operation at a predetermined advance time with respect to the first switching element. The controller controls, based on a voltage at the other end of the second switching element in a one-voltage holder, the first voltage output by the voltage converter.

The DC-DC power supply and a light emitting device according to the embodiment of the present invention are explained in detail below with reference to the drawings. Note that the embodiment explained below is an example of embodiments of the present invention. The present invention is not interpreted as being limited to this embodiment. In the drawings referred to in the embodiment, the same circuit portions or circuit portions having the same functions are denoted by the same or similar reference numerals and signs. Redundant explanation of the circuit portions is sometimes omitted. Dimension ratios of the drawings are sometimes different from actual ratios for convenience of explanation. One circuit of a component is sometimes omitted from the drawings.

### Embodiment

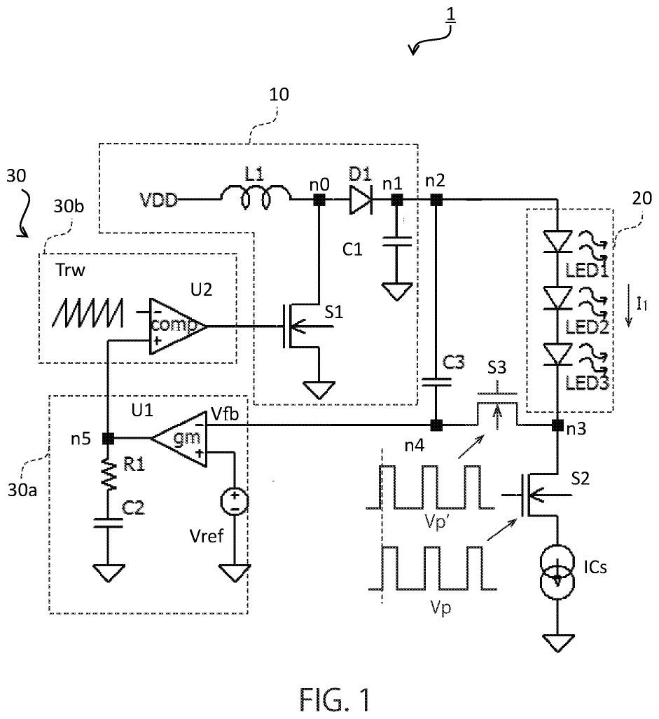

FIG. 1 is a block diagram showing the configuration of a DC-DC converter 1 according to an embodiment. The DC-DC converter 1 includes a voltage converter 10, a load 20, a controller 30, switching elements S2 and S3, a capacitor C3, and a constant current source ICs. Such a DC-DC converter 1 is a power supply capable of controlling light emission of an LED and configures a light emitting device.

The voltage converter 10 converts an input voltage VDD into a first voltage Vn1. The voltage converter 10 includes a switching element S1, an inductor L1, a diode D1, and a capacitor C1.

The driving switching element S1 is, for example, an n-type MOS transistor. A pulse signal is input to a gate of the switching element S1. A reference potential line (for example, a ground) is connected to a source of the switching element S1. A power supply line is connected to a drain of the switching element S1 via the inductor L1. An anode terminal of the diode D1 is connected to a connection node n0 of the inductor L1 and the switching element S1. A cathode terminal of the diode D1 is connected to the reference potential line via the capacitor C1, one end of which is connected to a connection node n1.

A pulse current output from the cathode terminal of the diode D1 is smoothed by charging the capacitor C1. The smoothed first voltage Vn1 is applied to one end (a connection node n2) of the load 20. In other words, the capacitor C1 holds the first voltage Vn1. Note that the capacitor C1 corresponds to a second voltage holder. The voltage converter 10 performs step-up conversion for converting the input voltage VDD into the first voltage Vn1. However, the voltage converter 10 is not limited to this. For example, the voltage converter 10 may perform step-down conversion.

The load 20 is, for example, a plurality of LEDs 1 to 3 connected in series. The load 20 is a driving target. A load current I1 is supplied to the load 20 via the constant current source ICs. The load current I1 flows to the reference potential line via the switching element S2 and the constant current source ICs. The LEDs 1 to 3 are, for example, white LEDs. Color rendering of the LEDs 1 to 3 is controlled by the load current I1 flowing to the white LEDs.

The switching element S2 is, for example, an n-type MOS transistor and is inserted on a current path of the load current I1. A pulse signal Vp is input to a gate of the switching element S2. A drain of the switching element S2 is connected to the other end (a connection node n3) of the load 20. A source of the switching element S2 is connected to the reference potential line via the constant current source ICs. The switching element S2 supplies the load current I1 to the load 20 according to the pulse signal Vp input to the gate. A light amount of the LEDs is controlled by a duty ratio of the pulse signal Vp. That is, the light amount of the LEDs is controlled according to a ratio of a light emission time and an extinction time of the LEDs. Note that the switching element S2 corresponds to the first switching element.

The switching element S3 is, for example, an n-type MOS transistor. A drain of the switching element S3 is connected to the connection node n3 of the load 20 and the switching element S2. A pulse signal Vp′ is input to a gate of the switching element S3. A source of the switching element S3 is connected to an inverted terminal of an error amplifier U1 of the controller 30 via a connection node n4. The switching element S3 is turned on and off according to the pulse signal Vp′. For example, the pulse signal Vp′ has a predetermined advance time with respect to the pulse signal Vp. A cycle and a duty ratio of the pulse signal Vp′ are the same as a cycle and a duty ratio of the pulse signal Vp.

One end of the capacitor C3 is connected to the connection node n2. The other end of the capacitor C3 is connected to the connection node n4. That is, the capacitor C3 holds a voltage between one end n2 of the load and the other end n4 of the switching element S3. Note that the capacitor C3 corresponds to a first voltage holder.

Since the pulse signal Vp′ has the predetermined advance time with respect to the pulse signal Vp as explained above, the switching element S3 is turned on a predetermined time earlier than the switching element S2 and is turned off the predetermined time earlier than the switching element S2. Accordingly, as explained below, the potential of the connection node n4 and the potential of the connection node n3 immediately before the switching element S3 is turned on are different. Similarly, the potential of the connection node n3 and the potential of the connection node n4 immediately after the switching element S3 is turned off are different.

The controller 30 controls, based on a voltage Vfb of the connection node n4, the first voltage Vn1 output by the voltage converter 10. The controller 30 includes an error amplifier 30a and a signal generator 30b.

The error amplifier 30a outputs an error signal based on the voltage difference between the voltage Vfb and a reference voltage Vref. The error amplifier 30a includes a differential amplifier U1, a resistor R1, and a capacitor C2.

The differential amplifier U1 is an amplifier that outputs, according to a gain gm, an electric current corresponding to a difference in an input voltage. The reference voltage Vref is input to a noninverted input terminal (+) of the differential amplifier U1. The voltage Vfb is input to an inverted input terminal (−) of the differential amplifier U1. That is, the voltage Vfb is a feedback signal of the first voltage Vn1.

An output terminal of the differential amplifier U1 is connected to one end of the capacitor C2 via the resistor R1. The other end of the capacitor C2 is connected to the reference potential line. A voltage generated in the capacitor C2 is input to a comparator U2 as an error signal via the resistor R1.

The signal generator 30b generates, based on an error signal, a PWM signal for turning on and off the driving switching element S1. The signal generator 30b includes the comparator U2. The error signal is input to a noninverted input terminal (+) of the comparator U2. A triangular wave signal Trw from a not-shown triangular wave generation circuit is input to an inverted input terminal (−) of the comparator U2. A PWM signal is output from the comparator U2.

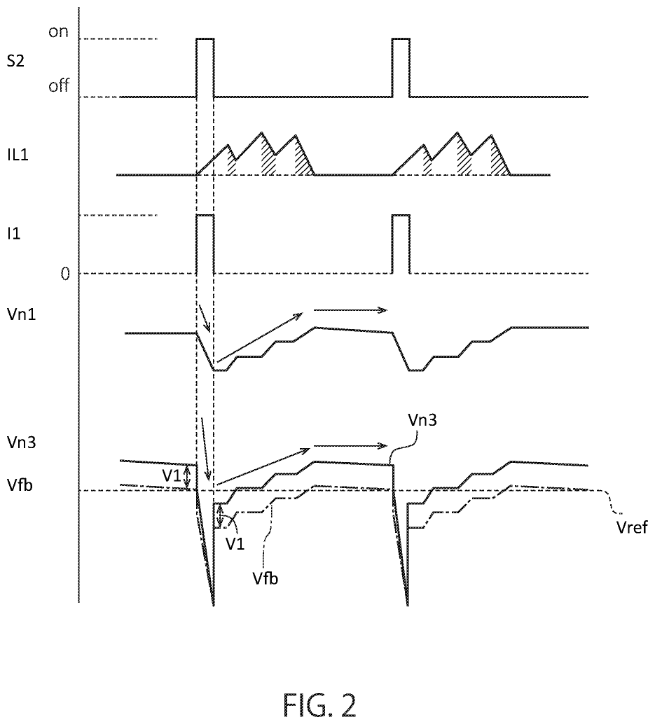

An operation example of the DC-DC converter 1 according to the embodiment is explained with reference to FIG. 2.

FIG. 2 is a waveform chart of the DC-DC converter according to the embodiment. The lateral axis indicates time. The vertical axis indicates, from the top, ON/OFF time of the switching element S2, an electric current IL1 flowing to the inductor L1, the load current I1, an output voltage Vn1, a voltage Vn3 of the connection node n3, and the voltage Vfb.

The electric current IL1 increases when the switching element S1 is turned on. The electric current IL1 decreases when the switching element S1 is turned off. ON/OFF duties are changed by the controller 30 to adjust a current amount and keep the output voltage Vn1. When the pulse signal Vp changes from a low level to a high level, the switching element S2 changes from OFF to ON. An electric current flowing to the load 20 changes from 0 to a constant load current I1. The constant load current I1 is supplied to the load 20. The voltage Vn1 drops according to elapse of an ON time of the switching element S2. Note that an integrated current of hatched regions of the electric current IL1 shown in FIG. 2 corresponds to a total amount of an electric current that can be supplied to the load 20.

A voltage of the load 20 discontinuously fluctuates by a voltage V1 when the switching element S2 changes from OFF to ON or from ON to OFF. The voltage Vn3 receives this steep fluctuation. As shown in FIG. 2, when the switching element S2 is turned on, the voltage Vn3 discontinuously drops by the voltage V1 and thereafter drops according to an ON state of the switching element S2. On the other hand, the switching element S3 is turned off a predetermined time before the drop voltage V1 due to the turn-off of the switching element S2 occurs. Therefore, the voltage Vfb deviates from the voltage Vn3 by the voltage V1. When the switching element S3 is turned on, the voltage Vfb becomes the same potential as the voltage Vn3.

When the switching element S2 is turned off, the voltage Vn3 discontinuously rises by the voltage V1 and thereafter steeply increases. The switching element S3 is turned off the predetermined time before the drop voltage V1 due to the turn-off of the switching element S2 occurs. Therefore, the voltage Vfb deviates from the voltage Vn3 by the voltage V1. In this way, the switching element S3 is capable of reducing the influence of the voltage V1 that discontinuously occurs because the switching element S3 is turned on and off a predetermined time before the switching element S2 is turned on and off. After the switching element S3 is turned off, the voltage Vfb follows the fluctuation of the voltage Vn1 while maintaining the voltage difference between the nodes n2 and n4 to which the capacitor C3 is connected. On the other hand, the voltage Vn3 follows the fluctuation of the voltage Vn1 while maintaining a voltage difference that occurs at both ends of the load 20.

The output voltage Vn1 starts rising according to the control by the controller 30 with an error signal based on the voltage difference between the voltage Vfb and the voltage Vref.

The voltage Vfb rises according to the rising of the output voltage Vn1 in a state in which the potential difference between the output voltage Vn1 and the capacitor C3 is maintained. When the voltage Vfb becomes potential equal to the voltage Vref, the electric current IL1 decreases to 0 and the output voltage Vn1 maintains fixed potential. The voltage Vn3 becomes fixed potential in a state in which potential is lower than the output voltage Vn1 by a potential difference due to the load 20. In this way, when the switching element S3 is turned off, even if an error occurs between the voltage Vfb and the voltage Vref, the voltage Vfb follows the output voltage Vn1 with the action of the capacitor C3. The voltage difference between the voltage Vfb and the voltage Vref decreases to 0 soon. The output voltage Vn1 is maintained at the fixed potential.

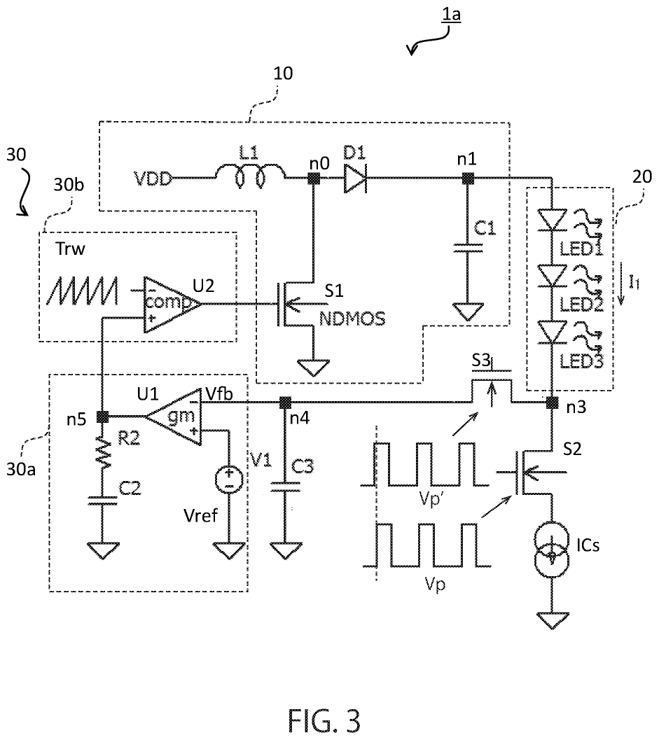

FIG. 3 is a block diagram showing the configuration of a DC-DC power supply 1a according to a comparative example. As shown in FIG. 3, the DC-DC power supply 1a is different from the DC-DC converter 1 according to this embodiment in that the capacitor C3 is connected between the other end n4 of the switching element S3 and the reference potential line. In the comparative example, when the switching element S3 is turned off, the voltage Vfb is maintained at the potential of the capacitor C3.

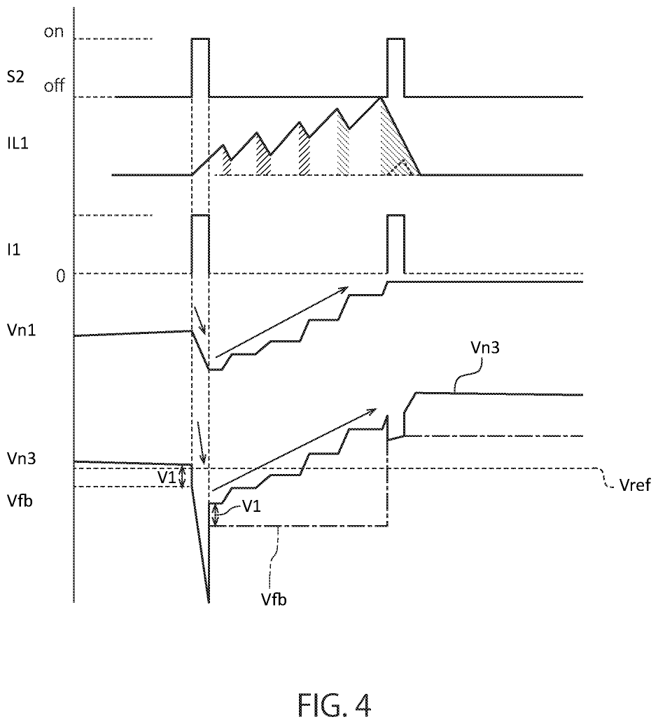

FIG. 4 is a waveform chart of the DC-DC power supply according to the comparative example. As in FIG. 2, the lateral axis indicates time. The vertical axis indicates, from the top, an ON/OFF time of the switching element S2, the electric current IL1 flowing to the inductor L1, the load current I1 flowing to the load 20, the voltage Vn1 applied to one end n1 of the load 20, the voltage Vn3 at the other end n3 of the load 20, and the voltage Vfb at the other end n4 of the switching element S3.

As shown in FIG. 4, when the switching element S3 is turned off by the pulse signal Vp, the voltage Vfb is maintained at the potential of the capacitor C3. Accordingly, in a period in which the switching element S3 is off, the voltage difference between the voltage Vfb and the voltage Vref is maintained at a fixed value. Consequently, a duty ratio of ON/OFF of the switching element S1 by the controller 30 increases. Accordingly, the electric current IL1 at the time when the switching element S1 is turned off continues to increase until the switching element S2 is turned off. Consequently, in some case, the electric current IL1 continues to be supplied to the capacitor C1 and the output voltage Vn1 continues to rise. The voltage Vn3 continues to rise in a state in which potential is lower than the output voltage Vn1 by a potential difference due to the load 20.

In order to reduce the voltage difference between the voltage Vfb and the voltage Vref to 0, for example, the voltage Vn1 sometimes rises until several cycles of the pulse signal Vp are required. In this case, for example, a fluctuation component of a subharmonic equal to or smaller than a fraction of a switching frequency of the driving switching element S1 sometimes occurs. In such a case, a phenomenon called “sound squeaking” in which noise is emitted from the capacitor C1 sometimes occurs.

The voltage Vn3 becomes constant potential in a state in which potential is lower than the output voltage Vn1 by a potential difference due to the load 20.

As explained above, according to this embodiment, the capacitor C3 is connected between one end n2 of the load 20 and the other end n4 of the switching element S3. Consequently, even when the switching element S3 is turned off, it is possible to control the voltage Vn1 in a state in which the potential difference between the voltage Vn1 applied to the load 20 and the voltage Vfb fed back to the controller 30 is maintained. Since the voltage Vfb also rises according to the rising of the voltage Vn1 with the action of the capacitor C3, the voltage Vfb and the reference voltage Vref can be matched. The voltage Vn1 can be controlled to a fixed voltage even when the load current I1 is stopped.

Since an increase of the voltage Vn1 can be suppressed, the phenomenon called “sound squeaking” in which noise is emitted from the capacitor C1 can be suppressed.

### (Modification of the Embodiment)

A DC-DC converter 1b according to a modification of the embodiment is different from a DC-DC converter 1 in that the switching element S3 is connected to the reference potential line via a resistor Rs instead of the constant current source ICs. In the following explanation, differences from the DC-DC converter 1 are explained.

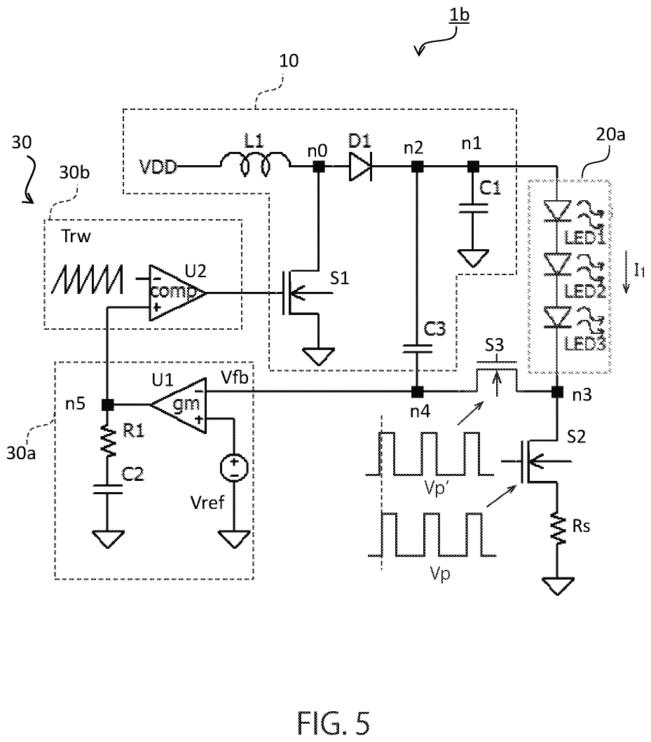

FIG. 5 is a block diagram showing the configuration of the DC-DC converter 1b according to the modification of the embodiment. In the DC-DC power supply 1b, the switching element S2 is connected to the reference potential line via the resistor Rs. Consequently, the load current I1 flows such that added-up potential of a load 20a, the switching element S2, and the resistor Rs is equal to the voltage Vn1.

In this case, the voltage Vn1 can be controlled in a state in which the potential difference between the voltage Vn1 applied to the load 20a and the voltage Vfb fed back to the controller 30 is maintained even when the switching element S3 is turned off. Consequently, since the voltage Vfb rises according to rising of the voltage Vn1, the voltage Vfb and the reference voltage Vref can be matched. The voltage Vn1 can be controlled to a fixed voltage even in a state in which the switching element S3 is turned off.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A DC-DC power supply comprising:
a voltage converter configured to convert an input voltage into a first voltage;
a first switching element configured to perform switching according to a pulse signal to thereby intermit the first voltage applied to one end of a load;
a second switching element, one end of which is connected to another end of the load, the second switching element performing an ON/OFF operation in synchronization with the first switching element;
a first voltage holder configured to hold a voltage between the one end of the load and another end of the second switching element; and
a controller configured to control the first voltage based on a voltage at the other end of the second switching element.

2. The DC-DC power supply according to claim 1, wherein the load is an LED.

3. The DC-DC power supply according to claim 2, further comprising a constant current source connected in series to the second switching element.

4. The DC-DC power supply according to claim 1, wherein the voltage converter further includes a second voltage holder configured to hold the first voltage applied to the one end of the load.

5. The DC-DC power supply according to claim 1, wherein the first voltage holder is a capacitor connected between the other end of the load and the other end of the second switching element.

6. The DC-DC power supply according to claim 1, wherein the voltage converter generates the first voltage from the input voltage by turning on and off a driving switching element to drive an inductor.

7. The DC-DC power supply according to claim 6, further comprising:
an error amplifier configured to output an error signal based on a voltage difference between the voltage at the other end of the second switching element and a reference voltage; and
a signal generator configured to generate, based on the error signal, a PWM signal for turning on and off the driving switching element.

8. The DC-DC power supply according to claim 3, wherein color rendering of the LED is controlled based on a constant current fed by the constant current source.

9. The DC-DC power supply according to claim 8, wherein a light amount of the LED is controlled by a duty ratio of the pulse signal.

10. A light emitting device comprising:
a group of a plurality of LEDs; and
a DC-DC power supply, wherein
the DC-DC power supply includes:
a voltage converter configured to convert an input voltage into a first voltage;
a first switching element configured to perform switching according to a pulse signal to thereby intermit the first voltage applied to one end of the LED group connected in series;
a second switching element, one end of which is connected to another end of the LED group, the second switching element performing an ON/OFF operation in synchronization with the first switching element;
a first voltage holder configured to hold a voltage between the one end of the LED group and another end of the second switching element; and
a controller configured to control the first voltage based on a voltage at the other end of the second switching element.

11. The light emitting device according to claim 10, wherein the LED group is a group of a plurality of white LEDs connected in series.

12. The light emitting device according to claim 11, further comprising a constant current source connected in series to the second switching element.

13. The light emitting device according to claim 10, wherein the voltage converter further includes a second voltage holder configured to hold the first voltage applied to the one end of the LED group.

14. The light emitting device according to claim 10, wherein the first voltage holder is a capacitor connected between the other end of the LED group and the other end of the second switching element.

15. The light emitting device according to claim 10, wherein the voltage converter generates the first voltage from the input voltage by turning on and off a driving switching element to drive an inductor.

16. The light emitting device according to claim 15, further comprising:
an error amplifier configured to output an error signal based on a voltage difference between the voltage at the other end of the second switching element and a reference voltage; and
a signal generator configured to generate, based on the error signal, a PWM signal for turning on and off the driving switching element.

17. The light emitting device according to claim 12, wherein color rendering of the LED group is controlled based on an electric current fed to the LED group by the constant current source.

18. The light emitting device according to claim 17, wherein a light amount of the LED group is controlled by a duty ratio of the pulse signal.
